(19) United States
(12) Patent Application Publication
(10) Pub. No.: US 2008/0153976 A1
(43) Pub. Date: Jun. 26, 2008

(54) Epoxy Resin, Epoxy Resin Composition, And Cured Material Thereof

(75) Inventors: Yasumasa Akatsuka, Sanyoonoda-shi (JP); Katsuhiko Oshimi, Tokyo (JP); Masataka Nakanishi, Tokyo (JP); Shigeru Moteki, Tokyo (JP)

Correspondence Address: DARBY & DARBY P.C., P.O. BOX 770, Church Street Station, New York, NY, 10008-0770, US

(73) Assignee: Nippon Kayaku Kabushiki Kaisha, Chiyoda-ku, Tokyo (JP)

(21) Appl. No.: 11/722,415

(22) PCT Filed: Dec. 21, 2005
(86) PCT No.: PCT/JP2005/023505

§ 371 Date: Jul. 16, 2007

(30) Foreign Application Priority Data
Dec. 21, 2004 (JP) 2004-369304

(51) Int. Cl. C08L 71/00; C08G 59/06; C08G 65/48

(52) U.S. Cl. 524/611; 528/87; 525/396

(57) ABSTRACT

An object of the present invention is to provide an epoxy resin that can be easily produced, can easily achieve a molecule-aligned state, and can be cured to provide a cured material with optical anisotropy and excellent toughness and thermal conductivity. The epoxy resin of the present invention is represented by the following formula (1):

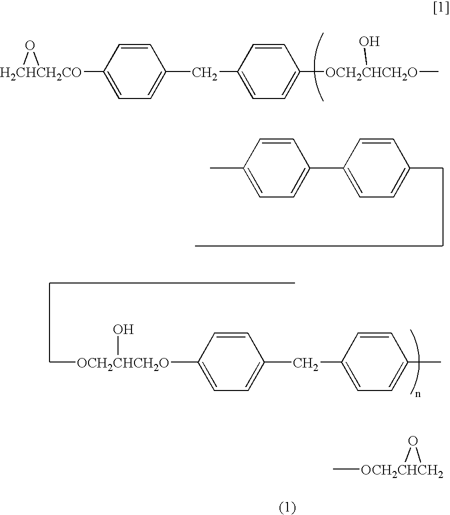

(wherein n is 0.1 to 20 (the number is an average). The epoxy resin of the present invention can be produced by extending the chain of an epoxide of 4,4′-bisphenol F with 4,4′-biphenol.

### TECHNICAL FIELD

The present invention relates to epoxy resins with high molecular orientation which can be cured to provide excellent toughness and thermal conductivity, epoxy resin compositions, and cured materials thereof.

### BACKGROUND ART

It is generally known that an epoxy resin composition forms a random network structure through a crosslinking reaction to provide a cured material with, for example, excellent heat resistance, water resistance, and insulation properties. Attempts have recently been made to align an epoxy resin composition in a particular direction by applying an external physical force during the curing of the composition to provide a cured material with enhanced properties. According to Patent Document 1, for example, an epoxy resin having mesogenic groups in its molecules can be cured to provide high thermal conductivity. Patent Document 2 reports that a cured material with excellent thermal conductivity can be provided by aligning an epoxy resin having a mesogenic group through the application of a magnetic field before curing the epoxy resin. In the field of thermoplastic resins, a molded material with excellent mechanical strength can be provided by processing a liquid crystal polymer at its melting point or higher, as discussed in, for example, Patent Document 3.

### Patent Document 1: Japanese Unexamined Patent Application Publication No. 2003-268070

### Patent Document 2: Japanese Unexamined Patent Application Publication No. 2004-175926

### Patent Document 3: Japanese Patent No. 2664405

### DISCLOSURE OF INVENTION

### Problems to be Solved by the Invention

In general, however, epoxy resins having mesogenic groups as disclosed in the above documents disadvantageously have complicated molecular structures and are therefore difficult to produce. The application of a magnetic field to the entire epoxy resin compositions, for example, is disadvantageous because it requires a large-scale apparatus. Thermoplastic liquid crystal polymers, which typically have a melting point of 250° C. to 350° C., generally require much severer molding conditions than thermosetting resins. An object of the present invention is to provide an epoxy resin that can be easily produced, can easily achieve a molecule-aligned state, and can be cured to provide a cured material with optical anisotropy and excellent toughness and thermal conductivity.

### Means for Solving the Problems

In light of the above circumstances, the inventors have completed the present invention as a result of intensive studies for development of an epoxy resin composition that can be easily produced and can easily achieve a molecule-aligned state.

That is, the present invention provides:

(1) An epoxy resin represented by the following formula (1):

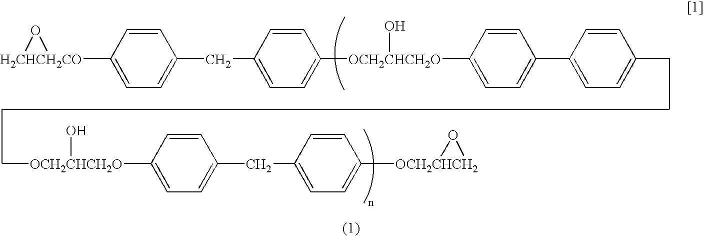

(wherein n is 0.1 to 20 (the number is an average), preferably 0.2 to 15, particularly preferably 0.5 to 5.0, which can be calculated from epoxy equivalent);

(2) An epoxy resin composition containing the epoxy resin according to Item (1) and a curing agent;

(3) The epoxy resin composition according to Item (2), further containing a curing accelerator;

(4) The epoxy resin composition according to one of Items (2) to (4), further containing an organic solvent;

(5) The epoxy resin composition according to one of Items (2) to (4), further containing an inorganic filler;

(6) A cured material formed by curing the epoxy resin composition according to one of Items (2) to (5); and

(7) A method for producing the epoxy resin according to Item (1), including allowing a phenolic compound represented by the following formula (2)

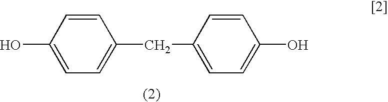

to react with an epihalohydrin in the presence of an alkali metal hydroxide to yield an epoxy resin having a low molecular weight, allowing the epoxy resin to react with 4,4′-biphenol, and adding a poor solvent to precipitate a crystal, wherein 4,4′-biphenol is represented by the following formula (3):

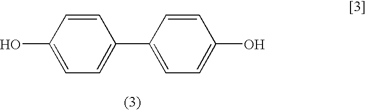

### Advantages

The epoxy resin of the present invention has significantly high molecular orientation and can be cured to provide excellent toughness and thermal conductivity. This epoxy resin is suitable for applications such as composite materials and electric/electronic materials, particularly, printed circuit boards, solder resists, semiconductor sealants, retardation films, molding materials, and adhesives.

### BEST MODE FOR CARRYING OUT THE INVENTION

An epoxy resin of the present invention can be produced by allowing a phenolic compound represented by the following formula (2):

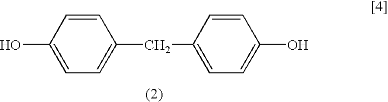

to react with an epihalohydrin in the presence of an alkali metal hydroxide to yield an epoxy resin having a low molecular weight, allowing the epoxy resin to react with 4,4′-biphenol, and precipitating a crystal from a solvent, wherein 4,4′-biphenol is represented by the following formula (3):

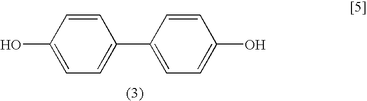

The phenolic compound of the formula (2) is a crystalline substance having a melting point of about 163° C.; one of commercially available products is, for example, p,p′-BPF (manufactured by Honshu Chemical Industry Co., Ltd.). The crystalline epoxy resin of the present invention can also be produced by allowing the compound of the formula (3) to react with the epihalohydrin and extending the chain of the reaction product with the compound of the formula (2), although this method has less working efficiency than the above method because the reaction product of the compound of the formula (3) with the epihalohydrin is highly crystalline.

In the method for producing the epoxy resin according to the present invention, the epihalohydrin used can be epichlorohydrin or epibromohydrin. The amount of epihalohydrin is generally 2 to 15 moles, preferably 3 to 12 moles, per mole of hydroxyl group of the compound of the formula (2).

The alkali metal hydroxide used can be, for example, sodium hydroxide or potassium hydroxide. The alkali metal hydroxide can be used as a solid or an aqueous solution. If an aqueous solution is used, it may be continuously added to the reaction system while water and the epihalohydrin are being removed and separated under a reduced or normal pressure, the water being drained and the epihalohydrin being continuously returned to the reaction system. The amount of alkali metal hydroxide used is generally 0.9 to 1.2 moles, preferably 0.95 to 1.15 moles, per equivalent of hydroxyl group of the compound of the formula (2). The reaction temperature is generally 20° C. to 110° C., preferably 25° C. to 100° C. The reaction time is generally 0.5 to 15 hours, preferably 1 to 10 hours.

Adding an alcohol, such as methanol, ethanol, propanol, or butanol, or a polar aprotic solvent, such as dimethyl sulfoxide or dimethyl sulfone, is preferred to facilitate the reaction.

If an alcohol is used, the amount of alcohol used is generally 3% to 30% by weight, preferably 5% to 20% by weight, of the amount of epichlorohydrin. If a polar aprotic solvent is used, the amount of polar aprotic solvent used is generally 10% to 150% by weight, preferably 15% to 120% by weight, of the amount of epihalohydrin.

Alternatively, the compound of the formula (2) may be allowed to react with the epihalohydrin by adding as a catalyst a quaternary ammonium salt, such as tetramethylammonium chloride, tetramethylammonium bromide, or trimethylbenzylammonium chloride, to the mixture of the compound of the formula (2) and the epihalohydrin, allowing them to react at 30° C. to 110° C. for 0.5 to 8 hours to yield a halohydrin ether compound of the compound of the formula (2), adding a solid or aqueous solution of an alkali metal hydroxide to the compound, and causing dehydrohalogenation (ring closure) at 20° C. to 100° C. for 1 to 10 hours.

The epoxidation product was heated under a reduced pressure after rinsing, or without rinsing, to remove, for example, excess epihalohydrin and solvent. An epoxy resin with a reduced content of hydrolyzable halogen can be provided by dissolving the recovered epoxy resin in, for example, toluene or methyl isobutyl ketone and adding an aqueous solution of an alkali metal hydroxide, such as sodium hydroxide or potassium hydroxide, to ensure ring closure. In this case, the amount of alkali metal hydroxide used is generally 0.01 to 0.3 moles, preferably 0.05 to 0.2 moles, per mole of hydroxyl group of the compound of the formula (2). The reaction temperature is generally 50° C. to 120° C. The reaction time is generally 0.5 to 2 hours.

After the reaction is completed, the reaction product is filtered or rinsed, for example, to remove salts and is heated under a reduced pressure to remove the solvent, thus yielding a low-molecular-weight epoxy resin (A). The epoxy resin (A) generally has an epoxy equivalent of 160 to 200 g/eq and contains bis(4-oxyglycidylphenyl)methane as a major component.

Next, impossible reaction of the epoxy resin (A) with 4,4′-biphenol, as represented by the formula (3), is induced to form a high-molecular-weight epoxy resin. The feed ratio of 4,4′-biphenol to the epoxy resin (A) is determined so that the hydroxyl groups of the compound of the formula (3) are contained in an amount of generally 0.05 to 0.95 moles, preferably 0.1 to 0.9 moles, per mole of epoxy group of the epoxy resin (A).

The impossible reaction can be induced without using a catalyst, although a catalyst is preferably used to facilitate the reaction. Examples of the catalyst used include triphenylphosphine, tetramethylammonium chloride, sodium hydroxide, potassium hydroxide, benzyltriphenylphosphonium chloride, butyltriphenylphosphonium, ethyltriphenylphosphonium iodide, and ethyltriphenylphosphonium bromide. The amount of catalyst used is generally 0.01 to 10 parts by weight, preferably 0.05 to 5 parts by weight, per mole of epoxy group of the epoxy resin (A).

In the impossible reaction, a solvent is preferably used to control the reaction temperature. Examples of the solvent used include cyclopentanone, cyclohexanone, methyl isobutyl ketone, methyl ethyl ketone, acetone, toluene, N-methylpyrrolidone, N,N-dimethyl sulfoxide, and N,N-dimethylformamide. The amount of solvent used is generally 5% to 150% by weight, preferably 10% to 100% by weight, of the total weight of the epoxy resin (A) and the compound of the formula (3).

The reaction temperature is generally 60° C. to 180° C., preferably 70° C. to 160° C. The reaction process can be tracked by, for example, gel permeation chromatography (GPC). The reaction is continued until the compound of the formula (3) is no longer detected. The reaction time is generally 0.5 to 15 hours, preferably 1 to 10 hours. The solvent is removed from the reaction mixture if necessary, thus yielding an epoxy resin (B) of the present invention. The epoxy resin (B) can be yielded as a crystalline powder, as described below, according to applications.

That is, after the completion of the reaction, crystals of the epoxy resin of the present invention are precipitated by adding a poor solvent and cooling it. Examples of the poor solvent used include methyl isobutyl ketone, methyl ethyl ketone, acetone, toluene, methanol, ethanol, and water. The amount of poor solvent used is generally 50% to 400% by weight, preferably 100% to 300% by weight, of the total weight of the epoxy resin (A) and the compound of the formula (3). The crystalline epoxy resin (B) can be yielded by filtering and drying the precipitated crystals. Alternatively, crystalline resin lumps can be formed by heating the resinous epoxy resin (B) to its melting point or higher and then gradually cooling it.

If no solvent is used in the impossible reaction, the epoxy resin of the present invention can be obtained in high yield by dissolving the reaction product in a good solvent such as N-methylpyrrolidone, dimethyl sulfoxide, or N,N-dimethylformamide, adding a water-soluble poor solvent such as methanol, ethanol, isopropanol, acetone, or methyl ethyl ketone, and adding water. In this case, the amount of good solvent used is generally 5% to 200% by weight, preferably 10% to 150% by weight, of the total weight of the epoxy resin (A) and the compound of the formula (3). The amount of water-soluble poor solvent used is generally 5% to 200% by weight, preferably 10% to 150% by weight, of the theoretical yield of the epoxy resin. The amount of water used is generally 50% to 400% by weight, preferably 100% to 300% by weight, of the total weight of the epoxy resin (A) and the compound of the formula (3).

The epoxy resin (B) thus yielded generally has a melting point of 70° C. to 180° C. in crystalline form.

The epoxy resin (B) of the present invention generally has an epoxy equivalent of 200 to 2,000 g/eq, preferably 250 to 1,500 g/eq, particularly preferably 250 to 1,000 g/eq. According to measurements using a differential scanning calorimeter (DSC), the epoxy resin (B) often shows two or more absorption peaks. This phenomenon indicates that the epoxy resin (B) is crystalline. On the other hand, a temperature region where the epoxy resin (B) exhibits optical anisotropy can be determined by observation using a polarizing microscope under temperature-increasing conditions. The epoxy resin (B) generally exhibits optical anisotropy at 100° C. to 200° C. In the formula (1) of the resultant epoxy resin, Wherein n is generally 0.1 to 20 (the number is an average), preferably 0.3 to 5, particularly preferably 0.5 to 2. The value of n can be estimated by GPC or NMR measurement or by calculation from the epoxy equivalent of the resin.

In preparation of an epoxy resin composition, the epoxy resin (B) can be used in a crystalline state or in a resinous state formed by heating the epoxy resin (B) to its melting point or higher and then supercooling the melted resin (B). The epoxy resin (B) in the resinous state generally has a softening point of 45° C. to 100° C.

An epoxy resin composition of the present invention will be described. The epoxy resin of the present invention can be used as a curable resin composition in combination with, for example, a curing agent, a curing accelerator, and a cyanate resin. Examples of applications include printed circuit boards, solder resists, semiconductor sealants, retardation films, molding materials, and adhesives.

The epoxy resin composition of the present invention contains the epoxy resin of the present invention and a curing agent as essential components. In the epoxy resin composition of the present invention, the epoxy resin of the present invention can be used alone or in combination with another epoxy resin. If another epoxy resin is used in combination, the content of the epoxy resin of the present invention in the entire epoxy resin is preferably 30% by weight or more, particularly preferably 40% by weight or more.

Examples of epoxy resins that can be used in combination with the epoxy resin of the present invention include bisphenol A epoxy resins, phenol novolak resins, biphenol epoxy resins, triphenylmethane epoxy resins, dicyclopentadiene-phenol condensate epoxy resins, biphenyl novolak epoxy resins, and alicyclic epoxy resins. These epoxy resins can be used alone or in combination of two or more of them.

The curing agent contained in the epoxy resin composition of the present invention can be, for example, an amine compound, an acid anhydride compound, an amide compound, or a phenolic compound. Examples of the curing agent used include, but not limited to, diaminodiphenylmethane, diethylenetriamine, triethylenetetramine, diaminodiphenyl sulfone, isophoronediamine, dicyandiamide, a polyamide resin synthesized from a dimer of linolenic acid and ethylenediamine, phthalic anhydride, trimellitic anhydride, pyromellitic anhydride, maleic anhydride, tetrahydrophthalic anhydride, methyltetrahydrophthalic anhydride, methylnadic anhydride, hexahydrophthalic anhydride, methylhexahydrophthalic anhydride, phenol novolak, modifications of the above compounds, imidazole, BF₃-amine complex, and guanidine derivatives. These curing agents can be used alone or in combination of two or more of them.

The amount of curing agent used in the epoxy resin composition of the present invention is preferably 0.7 to 1.2 equivalents per equivalent of epoxy group of the epoxy resin. If the amount of curing agent used falls below 0.7 equivalents or exceeds 1.2 equivalents per equivalent of epoxy group, the epoxy resin composition can be incompletely cured and thus fail to provide a curing material with excellent properties.

In addition, a curing accelerator can be used for the epoxy resin composition of the present invention. Examples of the curing accelerator used include imidazoles such as 2-methylimidazole, 2-ethylimidazole, and 2-ethyl-4-methylimidazole; tertiary amines such as 2-(dimethylaminomethyl)phenol and 1,8-diaza-bicyclo(5,4,0)undecene-7; phosphines such as triphenylphosphine; and metal compounds such as tin octylate. According to need, 0.1 to 5.0 parts by weight of curing accelerator is used for 100 parts by weight of the epoxy resin.

If necessary, the epoxy resin composition of the present invention can contain an inorganic filler. Examples of the inorganic filler used include silica, alumina, and talc. The amount of inorganic filler used is 0% to 90% of the weight of the epoxy resin composition of the present invention. The epoxy resin composition of the present invention can also contain a variety of additives such as a silane-coupling agent; a mold-releasing agent such as stearic acid, palmitic acid, zinc stearate, or calcium stearate; and a pigment.

The epoxy resin composition of the present invention can be prepared by homogeneously mixing the individual components. The epoxy resin composition of the present invention can easily be cured by a method similar to known methods. For example, a cured material can be formed by homogeneously mixing the epoxy resin of the present invention with a curing agent and optionally with a curing accelerator, an inorganic filler, and other additives using, for example, an extruder, a kneader, or a roller according to need to prepare an epoxy resin composition; melting and molding the epoxy resin composition by casting or using, for example, a transfer molding machine; and further heating the composition at 80° C. to 200° C. for two to ten hours.

A varnish composition (hereinafter simply referred to as a varnish) can be prepared by adding an organic solvent to the epoxy resin composition of the present invention. Examples of the solvents used include γ-butyrolactones; amide solvents such as N-methylpyrrolidone, N,N-dimethylformamide, N,N-dimethylacetamide, and N,N-dimethylimidazolidinone; sulfones such as tetramethylene sulfone; ether solvents such as diethylene glycol dimethyl ether, diethylene glycol diethyl ether, propylene glycol, propylene glycol monomethyl ether, propylene glycol monomethyl ether monoacetate, and propylene glycol monobutyl ether; ketone solvents such as methyl ethyl ketone, methyl isobutyl ketone, cyclopentanone, and cyclohexanone; and aromatic solvents such as toluene and xylene. The solvent is used in such an amount that the total solid content of the resultant varnish, other than the solvent content, falls within the range of generally 10% to 80% by weight, preferably 20% to 70% by weight.

To form a sheet of the epoxy resin composition of the present invention, the above varnish can be applied to a flat support by a known coating method, such as gravure coating, screen printing, a metal mask process, or spin coating, so that the coating has a predetermined thickness, for example, 5 to 100 μm, after drying. The coating method used is selected according to the type, shape, and size of substrate and the thickness of coating. The substrate used can be, for example, a film of a polymer and/or a copolymer thereof or a metal foil such as a copper foil. Examples of the polymer used include polyamides, polyamideimides, polyarylates, polyethylene terephthalate, polybutylene terephthalate, polyether ether ketones, polyether imides, polyether ketones, polyketones, polyethylene, and polypropylene. Particularly preferably, a polyimide or a metal foil is used. The coating can be heated to provide a cured sheet.

A cured material can also be formed by thermal press molding of a prepreg prepared by dissolving the epoxy resin composition of the present invention in a solvent such as toluene, xylene, acetone, methyl ethyl ketone, or methyl isobutyl ketone, impregnating a substrate such as glass fiber, carbon fiber, polyester fiber, polyamide fiber, alumina fiber, or paper with the solution, and drying the impregnated substrate by heating. In this case, the amount of solvent used is generally 10% to 70% by weight, preferably 15% to 70% by weight, of that of the mixture of the epoxy resin composition of the present invention and the solvent.

### EXAMPLES

The present invention will be described in more detail with reference to the examples below, where parts mean parts by weight unless otherwise specified.

### Example 1

First, 100 parts of a phenolic compound represented by the formula (2) (trade name: p,p′-BPF; manufactured by Honshu Chemical Industry Co., Ltd.), 370 parts of epichlorohydrin, and 26 parts of methanol were fed into a flask equipped with a thermometer, a condenser, a fractionating column, and a stirrer under nitrogen purging. The phenolic compound was completely dissolved by heating the mixture to 65° C. to 70° C. with stirring before 40.4 parts of sodium hydroxide flakes were added in fractions under reflux conditions over 100 minutes. The after-reaction was facilitated at 70° C. for additional one hour. The reaction product was rinsed twice with 150 parts of water and was heated under a reduced pressure to remove, for example, excess epichlorohydrin from the oil layer. The residues were dissolved in 312 parts of methyl isobutyl ketone and were allowed to react with 10 parts of 30% sodium hydroxide aqueous solution at 70° C. for one hour. The reaction product was rinsed three times to remove, for example, salts and was heated under a reduced pressure to remove methyl isobutyl ketone, thus yielding 150 parts of an epoxy resin (A1). This epoxy resin had an epoxy equivalent of 170 g/eq, a viscosity at 25° C. of 1,000 mP·s, and a total chlorine content of 1,200 ppm. Next, 85 parts of the epoxy resin (A1) was dissolved in 23 parts of the compound represented by the formula (3) with stirring and was allowed to react therewith at 160° C. for four hours by adding 0.08 parts of benzyltriphenylphosphonium chloride. The reaction was continued after 4,4′-biphenol disappeared completely in GPC. After the reaction was continued for six hours in total, the resultant resin was cooled to 100° C. and was completely dissolved in 108 parts of dimethyl sulfoxide. The solution was cooled to 60° C. and was mixed with 108 parts of methanol with stirring. The solution was then cooled to 30° C. and was mixed with 208 parts of water to precipitate crystals. These crystals were filtered and dried, thus yielding 103 parts of a white powder of an epoxy resin (B1) of the present invention. This epoxy resin (B1) had an epoxy equivalent of 443 g/eq (in the formula (1), n≈1.09 (average, calculated from the epoxy equivalent)). According to measurements using a differential scanning calorimeter (DSC), the epoxy resin (B1) had a melting point of 111° C. The DSC measurements also showed two peak tops at 125° C. and 160° C. Observation using a polarizing microscope at a rate of temperature increase of 1° C. per minute showed that the epoxy resin exhibited optical anisotropy at 140° C. to 160° C.

### Example 2

In Example 2, a vanish was prepared by homogenously mixing 8.9 parts of the epoxy resin (B1) yielded in Example 1; 3.5 parts of the phenol aralkyl resin XLC-3L (manufactured by Mitsui Chemicals, Inc.; melting point: 71° C.; hydroxyl equivalent: 174 g/eq), serving as a curing agent; 0.1 parts of 2PHZ-PW (manufactured by Shikoku Chemicals Corporation), serving as a curing accelerator; and 5.4 parts of cyclopentanone, serving as a solvent.

The vanish was applied to a PET film using an applicator so that the coating had a thickness of 20μ after drying. The coating was then heated at 140° C. for one hour to remove the solvent and cure the coating. After the PET film was removed, a colorless, clear, flexible cured film was obtained. This cured film was not cracked when folded and crumpled. Observation using a polarizing microscope showed that the film had optical anisotropy.

### Example 3

First, 100 parts of a phenolic compound represented by the formula (2) (trade name: p,p′-BPF; manufactured by Honshu Chemical Industry Co., Ltd.), 370 parts of epichlorohydrin, and 26 parts of methanol were fed into a flask equipped with a thermometer, a condenser, a fractionating column, and a stirrer under nitrogen purging. The phenolic compound was completely dissolved by heating the mixture to 65° C. to 75° C. with stirring before 41.6 parts of sodium hydroxide flakes were added in fractions under reflux conditions over 100 minutes. The after-reaction was facilitated at 70° C. for additional one hour. The reaction product was rinsed twice with 150 parts of water and was heated under a reduced pressure to remove, for example, excess epichlorohydrin from the oil layer. The residues were dissolved in 312 parts of methyl isobutyl ketone and were allowed to react with 10 parts of 30% sodium hydroxide aqueous solution at 70° C. for one hour. The reaction product was rinsed three times to remove, for example, salts and was heated under a reduced pressure to remove methyl isobutyl ketone, thus yielding 154 parts of an epoxy resin (A2). This epoxy resin had an epoxy equivalent of 164 g/eq. Next, 87 parts of the epoxy resin (A2) was dissolved in 23.3 parts of the compound represented by the formula (3) with stirring and was allowed to react therewith at 160° C. for four hours by adding 0.08 parts of triphenylphosphine. The reaction was continued after 4,4′-biphenol disappeared completely in GPC. After the reaction was continued for six hours in total, the reaction product was heated under a reduced pressure in a rotary evaporator to remove the solvent, thus yielding 110 parts of an epoxy resin (B2) of the present invention as a resinous solid. This epoxy resin (B2) had an epoxy equivalent of 410 g/eq (in the formula (1), n=0.96 (average, calculated from the epoxy equivalent)). The epoxy resin (B2) was heated to 100° C. and was then gradually cooled to form opaque crystalline resin lumps.

### Example 4 and Comparative Example 1

Compositions of Example 4 and Comparative Example 1 were prepared by mixing the epoxy resin (B2) of the present invention yielded in Example 3 and a high-molecular-weight bisphenol F epoxy resin (YDF-2001, manufactured by Tohto Kasei Co., Ltd.; epoxy equivalent: 471 g/eq), respectively, with a phenol novolak (H-1, manufactured by Meiwa Plastic Industries, Ltd.; hydroxyl equivalent: 105 g/eq), serving as a curing agent, and triphenylphosphine (TPP), serving as a curing accelerator, according to the compositions (parts by weight) shown in Table 1. These compositions were subjected to transfer molding to form molded resin materials. The molded materials were cured at 140° C. over eight hours.

TABLE 1

| | | | Comparative |
|---|---|---|---|
| | | Example 4 | Example 1 |
| Epoxy resin | B2 | 41.0 | 47.1 |
| | YDF2001 | | |
| Curing agent | Phenol | 10.5 | 10.5 |
| | novolak | | |
| Curing | TPP | 0.6 | 0.6 |
| accelerator | | | |

Table 2 shows measurements of the physical properties of the cured materials thus formed. These measurements were carried out by the following methods:

Fracture toughness (K1C): ASTM E-399

Thermal conductivity: ASTM E-1530

TABLE 2

| | | Comparative |
|---|---|---|
| | Example 4 | Example 1 |
| Fracture toughness | 95 | 32 |
| (K1C) (MPa) | | |
| Thermal conductivity | 0.41 | 0.20 |
| (W/mK) | | |

As described above, an epoxy resin of the present invention can be cured to provide a cured material with higher fracture toughness and thermal conductivity than those of known bisphenol F epoxy resins.

1. An epoxy resin represented by the following formula (1): 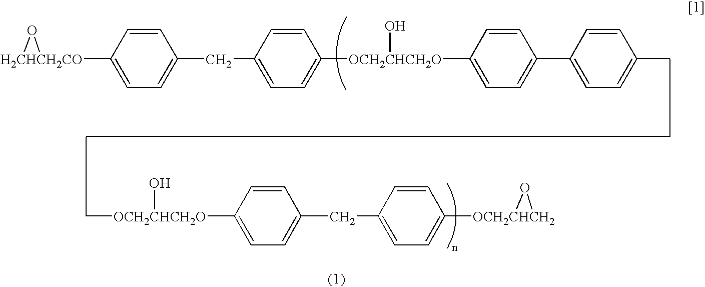
wherein n is an average number from 0.1 to 20.

2. An epoxy resin composition comprising the epoxy resin according to claim 1 and a curing agent.

3. The epoxy resin composition according to claim 2, further comprising a curing accelerator.

4. The epoxy resin composition according to claim 2, further comprising an inorganic filler.

5. The epoxy resin composition according to claim 4, further comprising an organic solvent.

6. A cured material formed by curing the epoxy resin composition according to claim 5.

7. A method for producing the epoxy resin according to claim 1, comprising reacting a phenolic compound represented by the following formula (2): 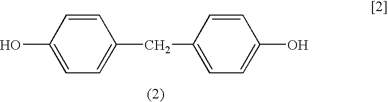
with an epihalohydrin in the presence of an alkali metal hydroxide to yield an epoxy resin having a low molecular weight, reacting the epoxy resin with 4,4′-biphenol, and adding a poor solvent to precipitate a crystal,
wherein 4,4′-biphenol is represented by the following formula (3):

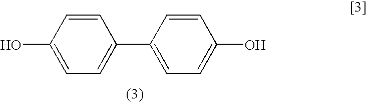

8. The epoxy resin composition according to claim 2, further comprising an inorganic filler.

9. The epoxy resin composition according to claim 2, further comprising an organic solvent.

10. A cured material formed by curing the epoxy resin composition according to claim 2.

11. The epoxy resin composition according to claim 3, further comprising an inorganic filler.

12. The epoxy resin composition according to claim 3, further comprising an organic solvent.

13. A cured material formed by curing the epoxy resin composition according to claim 3.

14. A cured material formed by curing the epoxy resin composition according to claim 4.
